(19) United States
(12) Patent Application Publication
(10) Pub. No.: US 2006/0262082 A1
(43) Pub. Date: Nov. 23, 2006

(54) Electrophoretic display unit

(76) Inventors: Mark Thomas Johnson, Eindhoven (NL); Guofu Zhou, Eindhoven (NL); Neculai Ailenei, Heerlen (NL)

Correspondence Address: PHILIPS INTELLECTUAL PROPERTY & STANDARDS, P.O. BOX 3001, BRIARCLIFF MANOR, NY, 10510, US

(21) Appl. No.: 10/570,533

(22) PCT Filed: Sep. 2, 2004
(86) PCT No.: PCT/IB04/51673

§ 371 Date: Mar. 3, 2006

(30) Foreign Application Priority Data
Sep. 11, 2003 (EP) 03103355.8

(51) Int. Cl. G09G 3/34

(52) U.S. Cl. 345/107

(57) ABSTRACT

Electrophoretic display units (1) are driven with a reduced amount of power by efficiently clocking a data signal into the data driving circuitry (30) only once and then supplying this data signal subsequently to two or more pixels (11) in two or more different lines. This can be done in case the pixels (11) in a same column require the same data pulse, like a shaking data pulse (Sh₁, Sh₂) or a reset data pulse (R). As a result, time is saved, which allows frame periods to be shorter. Even more time can be saved and even shorter frame periods are possible when combining the efficient clocking with the parallel driving of groups of lines (70-72).

The invention relates to an electrophoretic display unit, to a display device comprising an electrophoretic display unit, to a method for driving an electrophoretic display unit and to a processor program product for driving an electrophoretic display unit.

Examples of display devices of this type are: monitors, laptop computers, personal digital assistants (PDAs), mobile telephones and electronic books, electronic newspapers, and electronic magazines.

A prior art electrophoretic display unit is known from WO 99/53373, which discloses an electronic ink display comprising two substrates, with one of the substrates being transparent and having a common electrode (also known as counter electrode) and with the other substrate being provided with pixel electrodes arranged in rows and columns. A crossing between a row and a column electrode is associated with a pixel. The pixel is formed between a part of the common electrode and a pixel electrode. The pixel electrode is coupled to the drain of a transistor, of which the source is coupled to the column electrode or data electrode and of which the gate is coupled to the row electrode or selection electrode. This arrangement of pixels, transistors and row and column electrodes jointly forms an active matrix. A row driver (select driver) supplies a row driving signal or a selection signal for selecting a row of pixels and the column driver (data driver) supplies column driving signals or data signals to the selected row of pixels via the column electrodes and the transistors. The data signals correspond to data to be displayed, and form, together with the selection signal, a (part of a) driving signal for driving one or more pixels.

Furthermore, an electronic ink is provided between the pixel electrode and the common electrode provided on the transparent substrate. The electronic ink comprises multiple microcapsules with a diameter of about 10 to 50 microns. Each microcapsule comprises positively charged white particles and negatively charged black particles suspended in a fluid. When a positive voltage is applied to the pixel electrode, the white particles move to the side of the microcapsule directed to the transparent substrate, and the pixel becomes visible to a viewer. Simultaneously, the black particles move to the pixel electrode at the opposite side of the microcapsule where they are hidden from the viewer. By applying a negative voltage to the pixel electrode, the black particles move to the common electrode at the side of the microcapsule directed to the transparent substrate, and the pixel appears dark to a viewer. Simultaneously, the white particles move to the pixel electrode at the opposite side of the microcapsule where they are hidden from the viewer. When the electric voltages are removed, the display unit remains in the acquired state and exhibits a bi-stable character.

To reduce the dependency of the optical response of the electrophoretic display unit on the history of the pixels, preset data signals are supplied before the data-dependent signals are supplied. These preset data signals comprise data pulses representing energies which are sufficient to release the electrophoretic particles from a static state at one of the two electrodes, but which are too low to allow the electrophoretic particles to reach the other one of the electrodes. Because of the reduced dependency on the history of the pixels, the optical response to identical data will be substantially equal, regardless of the history of the pixels. The underlying mechanism can be explained by the fact that, after the display device is switched to a predetermined state, for example a black state, the electrophoretic particles come to a static state. When a subsequent switching to the white state takes place, the momentum of the particles is low because their starting speed is close to zero. This results in a high dependency on the history of the pixels resulting in a long switching time to overcome this high dependency. The application of the preset data signals increases the momentum of the electrophoretic particles and thus reduces the dependency resulting in a shorter switching time.

The time-interval required for driving all pixels in all rows once (by driving each row one after the other and by driving all columns simultaneously once per row) is called a frame. Per frame, each data pulse for driving a pixel requires, per row, a row driving action for supplying the row driving signal (the selection signal) to the row for selecting (driving) this row, and a column driving action for supplying the data pulse, like for example a data pulse of the preset data signals or a data pulse of the data-dependent signals, to the pixel. Usually, the latter is done for all pixels in a row simultaneously.

When updating an image, firstly a number of data pulses of the preset data signals are supplied, further to be called preset data pulses. Each preset data pulse has a duration of one frame period. The first preset data pulse, for example, has a positive amplitude, the second one a negative amplitude, and the third one a positive amplitude etc. Such preset data pulses with alternating amplitudes do not change the gray value displayed by the pixel.

During one or more subsequent frames, the data-dependent signals are supplied, with a data-dependent signal having a duration of zero, one, two to for example fifteen frame periods. Thereby, a data-dependent signal having a duration of zero frame periods, for example, corresponds with the pixel displaying full black assuming that the pixel already displayed full black. In case the pixel displayed a certain gray value, this gray value remains unchanged when the pixel is driven with a data-dependent signal having a duration of zero frame periods, in other words when being driven with a driving data pulse having a zero amplitude. A data-dependent signal having, for example, a duration of fifteen frame periods comprises fifteen driving data pulses and results in the pixel displaying full white, and a data-dependent signal having a duration of one to fourteen frame periods, for example, comprises one to fourteen driving data pulses and results in the pixel displaying one of a limited number of gray values between full black and full white.

The known electrophoretic display unit is disadvantageous, inter alia, due to the driving of the electrophoretic display unit requiring a relatively large amount of power.

It is an object of the invention, inter alia, to provide an electrophoretic display unit, in which the driving requires a relatively low amount of power.

The invention is defnined by the independent claims. The dependent claims define advantageous embodiments.

An electrophoretic display unit according to the invention comprises
an electrophoretic display panel comprising lines with pixels;
data driving circuitry for supplying data signals to the pixels; and
a controller for letting the data driving circuitry supply a data signal to at least two pixels in different lines.

By clocking at least one data signal only once into the data driving circuitry for two or more pixels in different lines of pixels, in other words by supplying at least one data signal only once to the data driving circuitry and then supplying the same data signal subsequently to two or more pixels in different lines of pixels, energy is saved. Further, as the data signals for a line of pixels are supplied to the data driving circuitry at least partly non-simultaneously, by supplying a data signal only once to the data driving circuitry for two or more pixels, time is saved in an advantageous way. The time required to load data signals into the data driving circuitry is a major limitation when trying to decrease the frame period. So, the electrophoretic display unit according to the invention has as additional advantage that frame periods and data pulses may be shortened.

In an embodiment the controller is adapted for letting the data driving circuitry provide all data signals destined for the pixels in a line, which data signals are supplied to the pixels in the different lines. As a result, the second one of the different lines of pixels can be addressed without having to load new data signals into the data driving circuitry, so much energy and time is saved.

The different lines may be subsequent lines.

In an embodiment of an electrophoretic display unit according to the invention the controller is adapted for letting the data driving circuitry provide the data signal to a pixel in each of the lines. As a result, an entire column is driven with a data signal which has been loaded only once, and much time and energy is saved.

An embodiment of an electrophoretic display unit according to the invention is defined by the controller being adapted to provide shaking data pulses, one or more reset data pulses, and one or more driving data pulses to the pixels. The shaking data pulses for example correspond with the preset data pulses discussed before. The reset data pulses precede the driving data pulses to further improve the optical response of the electrophoretic display unit, by defining a fixed starting point (fixed black or fixed white) for the driving data pulse. Alternatively, the reset data pulses precede the driving data pulses to further improve the optical response of the electrophoretic display unit, by defining a flexible starting point (black or white, to be selected in dependence of and closest to the gray value to be defined by the following driving data pulses) for the driving data pulses.

An embodiment of an electrophoretic display unit according to the invention is defined by the data signal being provided to the data driving circuitry for providing at least one shaking data pulse. Due to the shaking pulse usually being the same for all pixels in a frame, for all lines the shaking pulse can be clocked into the data driving circuitry only once per column. In case of only a part of an image needing to be shaked, the efficient clocking may be done for this part only.

An embodiment of an electrophoretic display unit according to the invention is defined by the data signal being provided to the data driving circuitry for providing at least one reset data pulse. In case of the reset pulse being the same for all pixels in a frame, for all lines the reset pulse can be clocked into the data driving circuitry only once per column. In case of only a part of an image needing to be resetted, the efficient clocking may be done for this part only.

An embodiment of an electrophoretic display unit according to the invention is defined by the data signal being provided to the data driving circuitry for providing at least one driving data pulse. In case of (a part of) an image requiring identical driving data pulses in at least one column for different lines (like for example in a picture-in-picture-situation), for (this part of) this image, per column the driving data pulse can be clocked into the data driving circuitry only once.

An embodiment of an electrophoretic display unit according to the invention is defined by further comprising line driving circuitry which comprises
a first line driver for in response to a first driving signal originating from the controller driving a first group of lines of the electrophoretic display unit; and
a second line driver for in response to a second driving signal originating from the controller driving a second group of lines of the electrophoretic display unit;
   wherein the controller is adapted to control the first and second line drivers for, during at least a data-independent part of a frame, driving a line of the first group and a line of the second group in parallel.

By introducing at least two line drivers each driving group of lines (usually rows), with the controller during at least a data-independent part of a frame driving the groups of lines in parallel, the efficiency of the driving has been further increased. Driving in parallel means that one or more lines of the first group and one or more lines of the second group are driven simultaneously, whereby during a data-independent part of a frame period, data-independent signals are (to be) supplied to the concerned lines. A data-independent part of a frame period either corresponds with one or more data-independent parts of a frame, like for example in a picture-in-picture-situation, or corresponds with an entire data-independent frame. During a data-dependent part of a frame, the controller does drive not the groups of lines in parallel (meaning that firstly all lines of the first group are driven, for example, one after the other and secondly all lines of the second group are driven, for example, one after the other etc.).

A simple, low cost driver drives one line at a time and is relatively unflexible. By using two or more of these simple low cost drivers for driving two or more groups of lines either in parallel or not, the flexibility of the driving is increased, without needing to develop and/or search for a more complex, more expensive driver which is more flexible. The invention is however not limited to simple, low cost drivers and may be used in combination with more complex, more expensive drivers as well.

Usually, but not exclusively, a frame corresponds with a time-interval used for driving all pixels in the electrophoretic display unit once (by driving each row one after the other and by driving all columns once per row, or vice versa). In other words, during a frame all lines of pixels are addressed one by one. By driving the first and second groups of lines in parallel during at least a data-independent part of a frame, less time is used for driving the lines during this part of a frame. As a result, for this frame, the frame rate is increased (the frame length is reduced), and for all frames of an image update cyclus, the average frame rate is increased, as, for example, a part of the frames comprises mainly data-independent parts, and another part of the frames comprises mainly data-dependent parts. An increased (average) frame rate results in a reduced flicker.

An embodiment of an electrophoretic display unit according to the invention is defined by the controller driving the first and second groups of lines with common data during at least a data-independent part of a frame and driving the first and second groups of lines with specific data during at least a data-dependent part of a frame. By driving the first and second groups of lines during at least a data-independent part of a frame with common data (meaning that pixels in one or more lines of the first group and pixels in one or more lines of the second group are driven with equal data), each two (or more) lines are driven with the same information. By driving the first and second groups of lines during at least a data-dependent part of a frame with specific data (meaning that pixels in each line of each group are driven uniquely with specific data which may be equal to or different from data (to be) supplied to pixels in other lines), each line is driven with unique information.

The display device as claimed in claim 8 may be an electronic book, while the storage medium for storing information may be a memory stick, integrated circuit, a memory like an optical or magnetic disc or other storage device for storing, for example, the content of a book to be displayed on the display unit.

Embodiments of method according to the invention and of a processor program product according to the invention correspond with the embodiments of an electrophoretic display unit according to the invention.

The invention is based upon an insight, inter alia, that it is relatively inefficient to clock identical data signals repeatedly into the data driving circuitry, and is based upon a basic idea, inter alia, that these identical data signals need to be supplied to the data driving circuitry only once.

The invention solves the problem, inter alia, of providing an electrophoretic display unit in which the driving requires a relatively low amount of power, and is advantageous, inter alia, in that energy and time are saved and the driving has become more efficient.

These and other aspects of the invention will be apparent from and elucidated with reference to the embodiments(s) described hereinafter.

In the drawings:

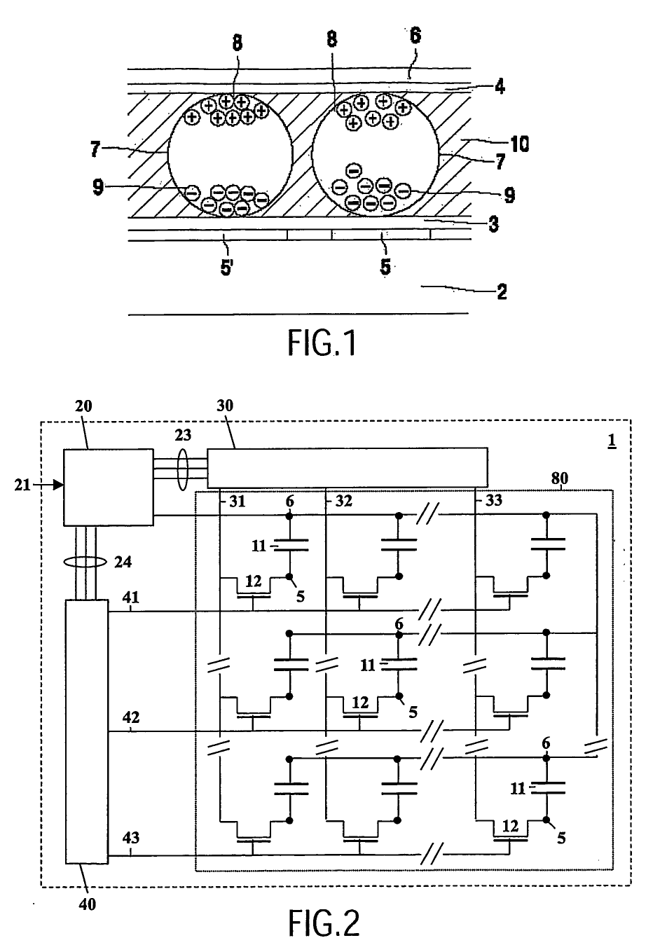

FIG. 1 shows (in cross-section) a pixel;

FIG. 2 shows diagrammatically an electrophoretic display unit;

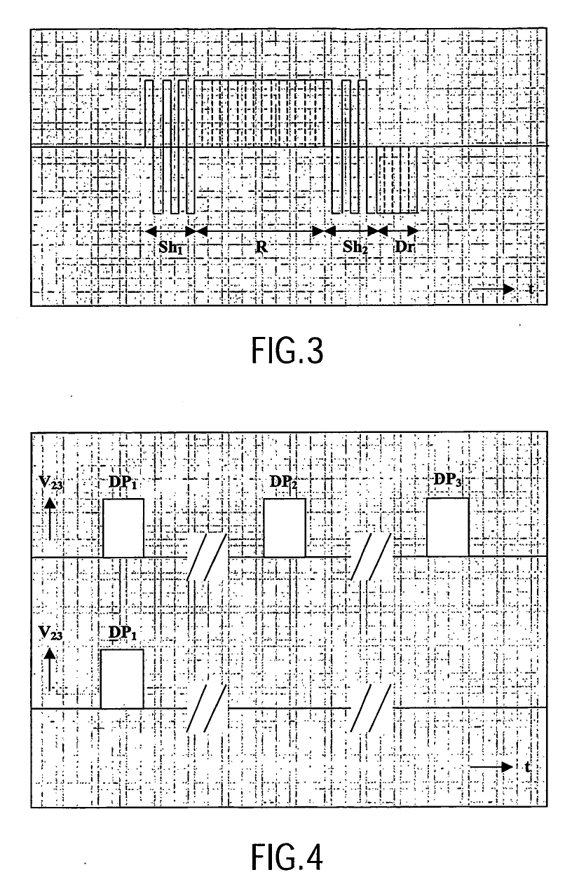

FIG. 3 shows a waveform for driving an electrophoretic display unit;

FIG. 4 shows a prior art data signal and a data signal according to the invention to be clocked into the data driving circuitry; and

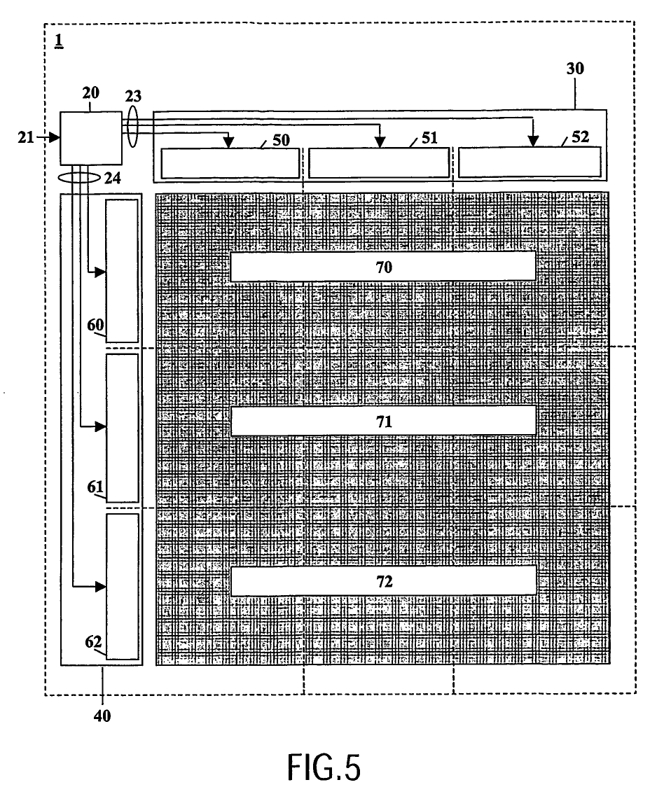

FIG. 5 shows diagrammatically an embodiment of an electrophoretic display unit according to the invention.

The pixel 11 of the electrophoretic display unit shown in FIG. 1 (in cross-section) comprises a base substrate 2, an electrophoretic film (laminated on base substrate 2) with an electronic ink which is present between two transparent substrates 3,4 of, for example, polyethylene. One of the substrates 3 is provided with transparent pixel electrodes 5 and the other substrate 4 is provided with a transparent common electrode 6. The electronic ink comprises multiple microcapsules 7 of about 10 to 50 microns in diameter. Each microcapsule 7 comprises positively charged white particles 8 and negatively charged black particles 9 suspended in a fluid 10. When a positive voltage is applied to the pixel electrode 5, the white particles 8 move to the side of the microcapsule 7 directed to the common electrode 6, and the pixel becomes visible to a viewer. Simultaneously, the black particles 9 move to the opposite side of the microcapsule 7 where they are hidden from the viewer. By applying a negative voltage to the pixel electrode 5, the black particles 9 move to the side of the microcapsule 7 directed to the common electrode 6, and the pixel appears dark to a viewer (not shown). When the electric voltage is removed, the particles 8,9 remain in the acquired state and the display exhibits a bi-stable character and consumes substantially no power. In alternative systems, particles may move in an in-plane direction, driven by electrodes which may be situated on the same substrate.

The electrophoretic display unit 1 shown in FIG. 2 comprises a display panel 80 comprising a matrix of pixels 11 at the area of crossings of line or row or selection electrodes 41,42,43 and column or data electrodes 31,32,33. These pixels 11 are all coupled to a common electrode 6, and each pixel 11 is coupled to its own pixel electrode 5. The electrophoretic display unit 1 further comprises line driving circuitry 40 (line or row or selection driver) coupled to the row electrodes 41,42,43 and data driving circuitry 30 (column or data driver) coupled to the column electrodes 31,32,33 and comprises per pixel 11 an active switching element 12. The electrophoretic display unit 1 is driven by these active switching elements 12 (in this example (thin-film) transistors). The line driving circuitry 40 consecutively selects the row electrodes 41,42,43, while the data driving circuitry 30 provides data signals to the column electrode 31,32,33. Preferably, a controller 20 first processes incoming data arriving via input 21 and then generates the data signals. Mutual synchronisation between the data driving circuitry 30 and the line driving circuitry 40 takes place via drive lines 23 and 24. Selection signals from the line driving circuitry 40 select the pixel electrodes 5 via the transistors 12 of which the drain electrodes are electrically coupled to the pixel electrodes 5 and of which the gate electrodes are electrically coupled to the row electrodes 41,42,43 and of which the source electrodes are electrically coupled to the column electrodes 31,32,33. A data signal present at the column electrode 31,32,33 is simultaneously transferred to the pixel electrode 5 of the pixel 11 coupled to the drain electrode of the transistor 12. Instead of transistors, other switching elements can be used, such as diodes, MIMs, etc. The data signals and the selection signals together form (parts of) driving signals.

The processor 20, the data driving circuitry 30, and the line driving circuitry 40 together form the driving circuit unit 20, 30, 40.

This driving circuit unit 20, 30, 40 may be formed by one or more integrated circuits, and may too further be combined with other components in an electronic unit.

Incoming data, such as image information receivable via input 21 is processed by controller 20. Thereto, controller 20 detects an arrival of new image information about a new image and in response starts the processing of the image information received. This processing of image information may comprise the loading of the new image information, the comparing of previous images stored in a memory of controller 20 and the new image, the interaction with temperature sensors, the accessing of memories containing look-up tables of drive waveforms etc. Finally, controller 20 detects when this processing of the image information is ready.

Then, controller 20 generates the data signals to be supplied to data driving circuitry 30 via drive lines 23 and generates the selection signals to be supplied to row driver 40 via drive lines 24. These data signals comprise data-independent signals which are the same for all pixels 11 and data-dependent signals which may or may not vary per pixel 11. The data-independent signals comprise shaking data pulses forming the preset data pulses, with the data-dependent signals comprising one or more reset data pulses and one or more driving data pulses. These shaking data pulses comprise pulses representing energy which is sufficient to release the electrophoretic particles 8,9 from a static state at one of the two electrodes 5,6, but which is too low to allow the particles 8,9 to reach the other one of the electrodes 5,6. Because of the reduced dependency on the history, the optical response to identical data will be substantially equal, regardless of the history of the pixels 11. So, the shaking data pulses reduce the dependency of the optical response of the electrophoretic display unit on the history of the pixels 11. The reset data pulse precedes the driving data pulse to further improve the optical response, by defining a flexible starting point for the driving data pulse. This starting point may be a black or white level, to be selected in dependence on and closest to the gray value defined by the following driving data pulse. Alternatively, the reset data pulse may form part of the data-independent signals and may precede the driving data pulse to further improve the optical response of the electrophoretic display unit, by defining a fixed starting point for the driving data pulse. This starting point may be a fixed black or fixed white level.

In FIG. 3, a waveform representing voltages across a pixel 11 as a function of time t is shown for driving an electrophoretic display unit 1. This waveform is generated using the data signals supplied via the data driving circuitry 30. The waveform comprises first shaking data pulses Sh₁, followed by one or more reset data pulses R, second shaking data pulses Sh₂ and one or more driving data pulses Dr. For example sixteen different waveforms are stored in a memory, for example a look-up table memory, forming part of and/or coupled to the controller 20. In response to data received via input 21, controller 20 selects a waveform for a pixel 11, and supplies the corresponding selection signals and data signals via the corresponding driving circuitry 30,40 and via the corresponding transistors 12 to the corresponding pixels 11.

A frame period corresponds with a time-interval used for driving all pixels 11 in the electrophoretic display unit 1 once (by driving each row one after the other and by driving all columns simultaneously once per row). For supplying data-dependent or data-independent signals to the pixels 11 during frames, the data driving circuitry 30 is controlled in such a way by the controller 20 that all pixels 11 in a row receive these data-dependent or data-independent signals simultaneously. This is done row by row, with the controller 20 controlling the line driving circuitry 40 in such a way that the rows are selected one after the other (all transistors 12 in the selected row are brought into a conducting state). In case of data-independent signals, more than one row may be selected simultaneously.

During a first set of frames, the first and second shaking data pulses Sh₁ and Sh₂ are supplied to the pixels 11, with each shaking data pulse having a duration of one frame period. The starting shaking data pulse for example has a positive amplitude, the next one a negative amplitude, and the next one a positive amplitude etc. Therefore, these alternating shaking data pulses do not change the gray value displayed by the pixel 11, as long as the frame period is relatively short.

During a second set of frames comprising one or more frames periods, a combination of reset data pulses R is supplied, further to be discussed below. During a third set of frames comprising one or more frames periods, a combination of driving data pulses Dr is supplied, with the combination of driving data pulses Dr either having a duration of zero frame periods and in fact being a pulse having a zero amplitude or having a duration of one, two to for example fifteen frame periods. Thereby, a driving data pulse Dr having a duration of zero frame periods for example corresponds with the pixel 11 displaying full black (in case the pixel 11 already displayed full black; in case of displaying a certain gray value, this gray value remains unchanged when being driven with a driving data pulse having a duration of zero frame periods, in other words when being driven with a data pulse having a zero amplitude). The combination of driving data pulses Dr having a duration of fifteen frame periods comprises fifteen subsequent pulses and for example corresponds with the pixel 11 displaying full white, and the combination of driving data pulses Dr having a duration of one to fourteen frame periods comprises one to fourteen subsequent data pulses and for example corresponds with the pixel 11 displaying one of a limited number of gray values between full black and full white.

The reset data pulses R precede the driving data pulses Dr to further improve the optical response of the electrophoretic display unit 1, by defining a fixed starting point (fixed black or fixed white) for the driving data pulses Dr. Alternatively, reset data pulses R precede the driving data pulses Dr to further improve the optical response of the electrophoretic display unit, by defining a flexible starting point (black or white, to be selected in dependence of and closest to the gray value to be defined by the following driving data pulses) for the driving data pulses Dr.

In case the same shaking/reset/driving data pulse needs to be supplied to two or more subsequent pixels 11 in the same column, for each selected row this data pulse is clocked into the data driving circuitry 30. For the first one of the two or more subsequent pixels 11, a first data pulse is clocked into the data driving circuitry 30, and for the second one of the two or more subsequent pixels, a second identical data pulse is clocked into the data driving circuitry 30. In other words, in that case in the data driving circuitry 30 a first data pulse is replaced by an identical second data pulse. The power required for this replacing can be avoided, according to the invention, as follows.

FIG. 4 shows in the upper graph a prior art data signal V₂₃ and in the lower graph a data signal V₂₃ according to the invention to be clocked into the data driving circuitry 30 via drive lines 23. The prior art data signal V₂₃ in the upper graph comprises a number of shaking/reset/driving data pulses DP₁, DP₂, DP₃ etc. of which three are shown. According to prior art, data pulse DP₁, for example, destined for a first pixel 11 in a first row is clocked into data driving circuitry 30, and then read out and/or supplied to the first pixel 11 in the first row via data electrode 31. Then, data pulse DP₂ for example destined for a first pixel 11 in a second row is clocked into data driving circuitry 30, which data pulse DP₂ replaces data pulse DP₁ in the data driving circuitry 30, and is then read out and/or supplied to, for example, a first pixel 11 in the second row via data electrode 31. Then, data pulse DP₃, for example, destined for a first pixel 11 in a third row is clocked into data driving circuitry 30, which data pulse DP₃ replaces data pulse DP₂ in the data driving circuitry 30, and is then read out and/or supplied to for example a first pixel 11 in the third row via data electrode 31 etc. In case the data pulses DP₁, DP₂, DP₃ have the same amplitude and width, so are identical data pulses, this replacing is inefficient.

The data signal V₂₃ according to the invention in the lower graph comprises one shaking/reset/driving data pulse DP₁. The data pulse DP₁ is, for example, destined for a first pixel 11 in a first, second, as well as third etc. row and is clocked into data driving circuitry 30, and then read out and/or supplied to the first pixel 11 in the first row via data 30 electrode 31, and is then read out and/or supplied to for example a first pixel 11 in the second row via data electrode 31, and is then read out and/or supplied to for example a first pixel 11 in the third row via data electrode 31 etc. As the data pulse DP₁ clocked only once into the data driving circuitry 30 and read out more than once and/or being supplied to subsequent pixels 11 in the same column, much energy is saved.

As the data pulses for a line of pixels 11 are supplied to the data driving circuitry 30 subsequently or in parallel for a limited number of columns like, for example, for two or four columns, time is saved by supplying at least one data signal only once to the data driving circuitry for two or more pixels 11 in two or more subsequent lines of pixels 11. The time required to load data signals into the data driving circuitry 30 is a major limitation when trying to decrease the frame period. The electrophoretic display unit 1 according to the invention allows frame periods and data pulses to be shorter.

For the sake of clarity, FIG. 4 only shows the data pulses DP₁ to be clocked into data driving circuitry 30 for two or more pixels 11 in the same column and to be supplied to these two or more pixels 11 via the same data electrode 31. In practice, for a line of pixels 11, all data pulses will need to be supplied to data driving circuitry 30 for all pixels in this line of pixels. Therefore, in case of all data pulses being supplied via the same drive line 23, in FIG. 4 instead of one data pulse DP₁ there should be a number of subsequent data pulses, with this number of data pulses being equal to the number of columns.

FIG. 5 shows an embodiment of the electrophoretic display unit 1 according to the invention comprising a main column driver 30 (corresponding with data driving circuitry 30 in FIG. 2) and a main row driver 40 (corresponding with line driving circuitry 40 in FIG. 2). Main column driver 30 comprises a first column driver 50, a second column driver 51 and a third column driver 52, which receive first driving signals via drive lines 23. Main row driver 40 comprises a first row driver 60, a second row driver 61 and a third row driver 62, which receive second driving signals via drive lines 24. The electrophoretic display unit 1 is partitioned into a first group of lines 70 driven by first row driver 60, a second group of lines 71 driven by second row driver 61, and a third group of lines 72 driven by third row driver 62. Each one of the groups 70-72 comprises lines with a variety of pixels 11.

During one or more data-independent (parts of) frames wherein data-independent signals are supplied, the groups of lines 70-72 are driven in parallel (meaning that one or more lines of the first group 70 and one or more lines of the second group 71 and one or more lines of the third group 72 are driven simultaneously). As a result of the combined driving during the data-independent (parts of) frames, the efficiency of the driving has been increased. During one or more data-dependent (parts of) frames, wherein data-dependent signals are supplied, the groups of lines 70-72 are not driven in parallel (meaning that, for example, firstly all lines of the first group 70 are driven one after the other, secondly all lines of the second group 71 and thirdly all lines of the third group 72. By driving the groups of lines 70-72 in parallel during at least one data-independent (part of a) frame, less time is used for driving the lines during this (part of the) frame. As a result, for this frame, the frame rate is increased, and for all frames of an image update cyclus, the average frame rate is increased, if, for example, some frames comprise mainly data-independent parts, and other frames comprise mainly data-dependent parts. An increased (average) frame rate results in a reduced flicker.

In combination with the single clocking of data signals into the data driving circuitry 30 and the double or more reading out of the data signals from the data driving circuitry 30, as described for FIG. 4, this parallel driving of groups of lines 70-72 saves even more time and allows frame periods and data pulses to be even shorter.

During one or more data-independent (parts of) frames, the groups of lines 70-72 are driven with common data (meaning that one or more lines of the first group 70 and one or more lines of the second group 71 and one or more lines of the third group 72 are driven with equal data, with pixels 11 in these lines receiving the same data-independent signal), in which case each three (or more) lines are driven with the same information. During one or more data-dependent frames, the groups of lines 70-72 are driven with specific data (meaning that each line of each group 70-72 is driven uniquely with specific data which may possibly be equal to but usually is different from data (to be) supplied to other lines, with pixels 11 in each line receiving possibly the same but usually a different data-dependent signal compared to pixels 11 in other lines), in which case each line is driven with unique information.

Of course, with the previous paragraphs describing the parallel driving of groups of horizontal lines (rows) during one or more frames, groups of vertical lines (columns) can be driven in parallel as well, and the invention is not limited to groups of horizontal lines (rows) being driven in parallel during one or more (parts of) frames. However, the parallel driving of groups of horizontal lines (rows) is particularly advantageous, due to each row driver 60-62, when driving a row of pixels 11, bringing all transistors 12 coupled to the pixel electrodes 5 of the pixels 11 in this row in a conducting state, after which the column drivers 50-52 can supply the data simultaneously to the pixels 11 in this row via the conducting transistors 12 without these transistors 12 needing to be individually and/or sequentially switched. So, a minimum number of switching actions is required.

Preferably, to increase the frame rate of the electrophoretic display unit 11, for data-independent signals (like, for example, the shaking pulses and, depending on the application, the reset pulses), groups of lines 70-72 should be driven in parallel and with common data For data-dependent signals (like for example driving pulses etc.), the groups of lines 70-72 are not driven in parallel and are driven with specific data. It is preferred if, in particular, the row drivers 60-62 are driven in parallel. By driving, for example, two row drivers in parallel, the frame rate may be halved. These extremely short frame periods are particularly beneficial for the shaking pulses.

If the drive lines 23 (24) are three separate drive lines, either these three separate drive lines are coupled directly to controller 20 or they are coupled indirectly to controller 20 via, for example, a multiplexer. Depending on the required driving, so parallel or not, the controller ensures that the adequate data signals are supplied via the optional multiplexer (not shown) and the data driving circuitry to the corresponding pixels (11). Information about how the data signals have to be provided to the pixels (11), like parallel driving, or which lines are to be driven in parallel, may be included in the drive signals transferred via the drive lines 23, 24. Alternatively, one or more separate lines may be used between the controller 20 and the data driving circuitry 30, the row driver 40 and/or the multiplexer. In case the drive lines 23, respectively 24 each consist of one physical connection, further information is to be provided by the controller 20 for indicating which parts of the driver signals have to be processed by which driver 50-52, respectively 60-62.

Minimally, there will be two column drivers 50,51 and one row driver 60, or one column driver 50 and two row drivers 60,61. Maximally, there will be as many column drivers as there are columns of pixels 11, and as many row drivers as there are rows of pixels 11.

Controller 20 comprises and/or is coupled to a memory (not shown) like, for example, a look-up table memory for storing information about data signals to be supplied to at least two pixels 11 in at least two subsequent lines being equal or not and/or about data signals needing to be clocked per line or once for several lines.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. An electrophoretic display unit (1) comprising:
an electrophoretic display panel (80) comprising lines with pixels (11);
data driving circuitry (30) for supplying data signals to the pixels (11); and
a controller (20) for letting the data driving circuitry (30) supply a data signal to at least two pixels (11) in different lines.

2. An electrophoretic display unit (1) as claimed in claim 1, wherein the controller (20) is adapted for letting the data driving circuitry (30) provide all data signals destined for the pixels (11) in a line, which data signals are supplied to the pixels (11) in the different lines.

3. An electrophoretic display unit (1) as claimed in claim 1, wherein the different lines are subsequent lines.

4. An electrophoretic display unit (1) as claimed in claim 1, wherein the controller (20) is adapted for letting the data driving circuitry (30) provide the data signal to a pixel (11) in each of the lines.

5. An electrophoretic display unit (1) as claimed in claim 1, wherein the controller (20) is adapted to provide
shaking data pulses (Sh₁,Sh₂);
one or more reset data pulses (R); and
one or more driving data pulses (Dr);
to the pixels (11), the data signal representing one or more of the data pulses (Sh₁, Sh₂, R, Dr).

6. An electrophoretic display unit (1) as claimed in claim 1, further comprising line driving circuitry (40) which comprises
a first line driver (60) for in response to a first driving signal originating from the controller (20) driving a first group of lines (70) of the electrophoretic display unit (1); and
a second line driver (61) for in response to a second driving signal originating from the controller (20) driving a second group of lines (71) of the electrophoretic display unit (1);
wherein the controller (20) is adapted to control the first and second line drivers (60,61) for, during at least a data-independent part of a frame, driving a line of the first group (70) and a line of the second group (71) in parallel.

7. An electrophoretic display unit (1) as claimed in claim 6, wherein the controller (20) drives the first and second groups of lines (70,71) with common data during at least a data-independent part of a frame and drives the first and second groups of lines (70,71) with specific data during at least a data-dependent part of a frame.

8. A display device comprising an electrophoretic display unit (1) as claimed in claim 1; and comprising a storage medium for storing information to be displayed.

9. A method for driving an electrophoretic display unit (1) which comprises an electrophoretic display panel (80) comprising lines with pixels (11), the method comprising the step of:
supplying a data signal to at least two pixels (11) in different lines.

10. A processor program product for driving an electrophoretic display unit (1) which comprises an electrophoretic display panel (80) comprising lines with pixels (11), the processor program product comprising the function of:
supplying a data signal to at least two pixels (11) in different lines.

11. Driving circuit unit (20, 30, 40) for driving as electrophoretic display panel (80) comprising lines with pixels (11), the driving circuit unit (20, 30, 40) comprising data driving circuitry (30) for supplying data signals to the pixels (11); and a controller (20) for letting the data driving circuitry (30) supply a data signal to at least two pixels (11) in different lines.
